(19) United States
(12) Patent Application Publication
(10) Pub. No.: US 2015/0315968 A1
(43) Pub. Date: Nov. 5, 2015

(54) FUEL SUPPLY SYSTEM

(71) Applicant: General Electric Company, Schenectady, NY (US)

(72) Inventors: Carlos Gabriel Roman, Simpsonville, SC (US); Alberto Jose Negroni, Simpsonville, SC (US)

(73) Assignee: General Electric Company, Schenectady, NY (US)

(21) Appl. No.: 14/268,650

(22) Filed: May 2, 2014

(51) Int. Cl. F02C 7/22

(52) U.S. Cl. CPC F02C 7/222

(57) ABSTRACT

A fuel supply system includes a fuel manifold and a main fuel line path configured to receive a fuel from the fuel manifold. The main fuel line path routes the fuel to a combustion inlet region. The fuel supply system also includes a secondary fuel line path having an inlet configured to receive a portion of the fuel and an outlet configured to route the portion of the fuel to the main fuel line path through an outlet at a location of the main fuel line path that is downstream of the inlet of the secondary fuel line path. A storage volume is fluidly coupled to the secondary fuel line path and is configured to cyclically store and release the portion of the fuel.

### BACKGROUND OF THE INVENTION

The subject matter disclosed herein relates to fuel supply systems and, more particularly, to a fuel supply system configured to route fuel to a combustion assembly of a gas turbine engine.

In a gas turbine engine, air is pressurized in a compressor and mixed with fuel in a combustor for generating hot combustion gases that flow downstream through turbine stages where energy is extracted. Large industrial power generation gas turbine engines typically include a plurality of combustor cans within which combustion gases are separately generated and collectively discharged.

Of particular concern to effective operation of can combustor engines is combustion dynamics (i.e., dynamic instabilities in operation). High dynamics are often caused by fluctuations in conditions such as the temperature of the exhaust gases (i.e., heat release) and oscillating pressure levels within a combustor can. Such high dynamics can limit hardware life and/or system operability of an engine, causing such problems as mechanical and thermal fatigue. Combustor hardware damage can come about in the form of mechanical problems relating to fuel nozzles, liners, transition pieces, transition piece sides, radial seals, and impingement sleeves, for example.

Various attempts to control combustion dynamics have been made in an effort to prevent degradation of system performance. Such efforts include, for example, reducing dynamics by decoupling the pressure and heat release oscillations (e.g., by changing the flame shape, location, etc. to control heat release within a combustion engine) or “de-phasing” the pressure and heat release. A resonator is one component that has been employed to achieve such dynamics reductions. However, increasing power output requirements results in a smaller window of combustion operability since matching of combustion and turbine frequencies is to be avoided.

This smaller window poses enhanced difficulty in the prior efforts aimed at frequency avoidance.

### BRIEF DESCRIPTION OF THE INVENTION

According to one aspect of the invention, a fuel supply system includes a fuel manifold. Also included is a main fuel line path configured to receive a fuel from the fuel manifold and route the fuel to a combustion inlet region. Further included is a secondary fuel line path having an inlet configured to receive a portion of the fuel and an outlet configured to route the portion of the fuel to the main fuel line path through an outlet at a location of the main fuel line path that is downstream of the inlet of the secondary fuel line path. Yet further included is a storage volume fluidly coupled to the secondary fuel line path and configured to cyclically store and release the portion of the fuel.

According to another aspect of the invention, a fuel supply system for a gas turbine engine includes a fuel manifold. Also included is a main fuel line path configured to receive a fuel from the fuel manifold and route the fuel to a combustion inlet region. Further included is a secondary fuel line path having an inlet configured to receive a portion of the fuel and an outlet configured to route the portion of the fuel to the main fuel line path through an outlet. Yet further included is a storage volume fluidly coupled to the secondary fuel line path and configured to cyclically store and release the portion of the fuel. Also included is a control valve located along the secondary fuel line path between the storage volume and the outlet of the secondary fuel line path, wherein the control valve is configured to oscillate between an open condition and a closed condition in response to a pressure detected within the storage volume. Further included is a first orifice disposed in the main fuel line path to regulate a main fuel line path flow rate. Yet further included is a second orifice disposed in the secondary fuel line path to regulate a secondary fuel line path flow rate, wherein the inlet of the secondary fuel line path is located upstream of the first orifice and the outlet of the secondary fuel line path is located downstream of the first orifice.

According to yet another aspect of the invention, a gas turbine system includes a compressor, a combustion assembly having at least one combustion chamber, and a turbine section. Also included is a fuel supply system configured to route fuel to the combustion assembly. The fuel supply system includes a fuel manifold. The fuel supply system also includes a main fuel line path configured to receive a fuel from the fuel manifold and route the fuel to a combustion inlet region of the combustion assembly. The fuel supply system further includes a secondary fuel line path having an inlet configured to redirect a portion of the fuel away from the main fuel line path. The fuel supply system yet further includes a storage volume fluidly coupled to the secondary fuel line path and configured to cyclically store and release the portion of the fuel in response to a pressure differential between the main fuel line path and the secondary fuel line path.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a schematic illustration of a fuel supply system for delivering fuel to the gas turbine engine; and

FIG. 3 illustrates a plurality of intervals of oscillation of fuel mass flow of the fuel supply system.

The detailed description explains embodiments of the invention, together with advantages and features, by way of example with reference to the drawings.

### DETAILED DESCRIPTION OF THE INVENTION

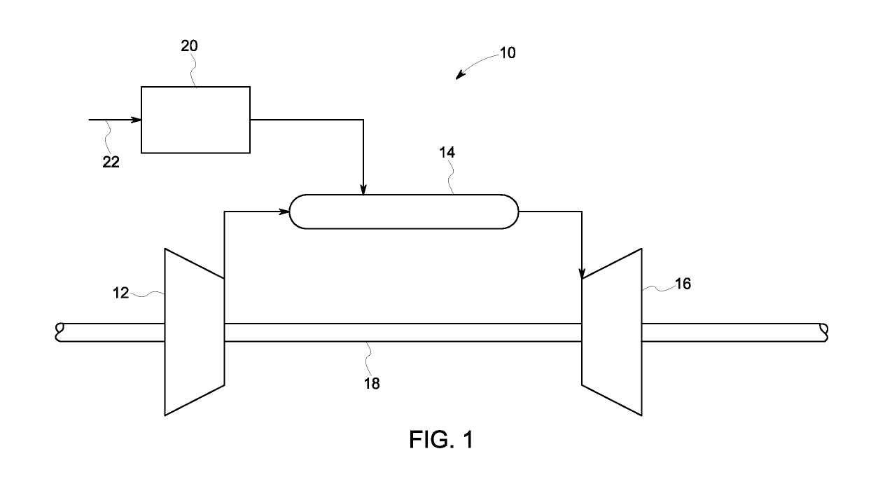

Referring to FIG. 1, a gas turbine engine 10, constructed in accordance with an exemplary embodiment of the invention, is schematically illustrated. The gas turbine engine 10 includes a compressor section 12, a combustion assembly 14, a turbine section 16, a shaft 18 and a fuel supply system 20. It is to be appreciated that one embodiment of the gas turbine engine 10 may include a plurality of compressor sections 12, combustion assemblies 14, turbine sections 16, and/or shafts 18. The compressor section 12 and the turbine section 16 are coupled by the shaft 18. The shaft 18 may be a single shaft or a plurality of shaft segments coupled together to form the shaft 18.

In operation, air flows into the compressor section 12 and is compressed into a high pressure gas. The high pressure gas is supplied to the combustion assembly 14 and mixed with a fuel 22, for example process gas and/or synthetic gas (syngas). Alternatively, the combustion assembly 14 can combust fuels that include, but are not limited to natural gas and/or fuel oil. The fuel/air or combustible mixture is ignited to form a high pressure, high temperature combustion gas stream. Thereafter, the combustion assembly 14 channels the combustion gas stream to the turbine section 16, which converts thermal energy to mechanical, rotational energy.

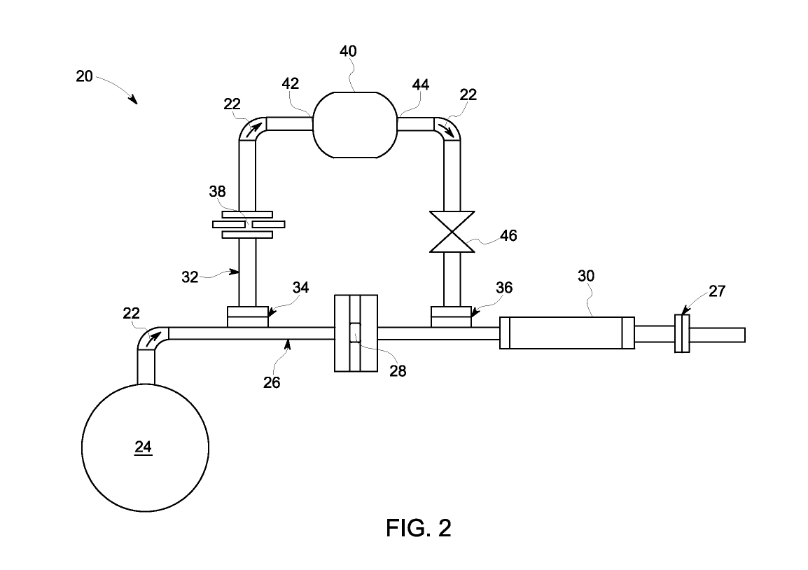

Referring now to FIG. 2, the fuel supply system 20 configured to route the fuel 22 to the combustion assembly 14 is illustrated in greater detail. A fuel manifold 24 directs the fuel 22 from a supply (not illustrated) to a main fuel line path 26. The main fuel line path 26 extends between the fuel manifold 24 and the combustion assembly 14. In particular, the main fuel line path 26 provides a path for the fuel 22 to flow to a combustion inlet region 27 of the combustion assembly 14, such as a plenum and/or fuel injection nozzle. The main fuel line path 26 is formed of at least one pipe segment, but typically a plurality of pipe segments are operatively coupled to each other, such as in a welded manner.

Disposed along the main fuel line path 26 is a first orifice 28 that is configured to regulate flow of the fuel 22 within the main fuel line path 26. The first orifice 28 is sized to result in desirable flow characteristics of the fuel 22 within the main fuel line path 26. Typically, the first orifice 28 is sized to include a cross-sectional area that is smaller than the remainder of the main fuel line flow path 26. In one embodiment, a piping structure 30 is included downstream of the first orifice 28 along the main fuel line path 26. The piping structure 30 is a connector that may be referred to as a “pigtail” in the industry and connects the main fuel line path 26 to a fuel injector or a fuel pre-mixer of the combustion assembly 14.

A secondary fuel line path 32 is illustrated and is a secondary routing path for the fuel 22. As is the case with the main fuel line path 26 described above, the secondary fuel line path 32 is formed of at least one pipe segment, but typically a plurality of pipe segments are operatively coupled to each other, such as in a welded manner. The secondary fuel line path 32 includes an inlet 34 and an outlet 36. In the illustrated embodiment, the inlet 34 is located between the fuel manifold 24 and the first orifice 28 of the main fuel line path 26, thereby branching the secondary fuel line path 32 directly off of the main fuel line path 26. In yet another embodiment, the inlet 34 is located in a directly fluidly coupled configuration with the fuel manifold 24. Regardless of the precise location of the inlet 34, it is configured to receive a portion of the fuel 22 that is supplied from the fuel manifold 24, thereby redirecting the portion of the fuel 22 to the secondary fuel line path 32 that would otherwise flow in an uninterrupted manner through the main fuel line path 26. The secondary fuel line path 32 routes the portion of the fuel 22 therethrough and includes a plurality of components therealong that will be described in detail below.

A second orifice 38 is disposed downstream of the inlet 34 within the secondary fuel line path 32 and is configured to regulate flow of the portion of the fuel 22 within the secondary fuel line path 32. Alternatively, a control valve may be employed in this location. The second orifice 38 (or control valve) is sized to result in desirable flow characteristics of the fuel 22 within the secondary fuel line path 32. Typically, the second orifice 38 is sized to include a cross-sectional area that is smaller than the remainder of the secondary fuel line flow path 32.

Downstream of the second orifice 38 is a storage volume 40 that is fluidly coupled to the secondary fuel line path 32. In an alternative embodiment, the second orifice 38 is located downstream of the storage volume 40. The storage volume 40 may be any type of structure having a volume suitable for containing the portion of the fuel 22 passing through the secondary fuel line path 32, such as a tank, for example. Irrespective of the precise structure of the storage volume 40, the portion of the fuel 22 passing through the secondary fuel line path 32 enters a volume inlet 42 of the storage volume 40 and is expelled via a volume outlet 44.

The storage volume 40 is configured to accumulate the fuel 22 passing through the secondary fuel line path 32 and subsequently expel its contents for further routing through the secondary fuel line path 32 in a cyclical manner. The accumulation and expulsion of the fuel 22 within the storage volume 40 is dictated by a control valve 46 that is located at a position of the secondary fuel line path 32 that is downstream of the storage volume 40, but upstream of the outlet 36 of the overall structure of the secondary fuel line path 32. Alternatively, the control valve 46 is located upstream of the storage volume 40. The control valve 46 may be any suitable valve construction that is configured to move between an open condition and a closed condition, including a passive or active device. Oscillation between the open condition and the closed condition may be based on predetermined time intervals that facilitate a time-dependent cycling of the accumulation and expulsion of the storage volume 40. Alternatively, the control valve 46 may oscillate between the open condition and the closed condition based on a pressure detected within the storage volume 40. In one embodiment, the storage volume 40 includes a pressure sensor within the interior of the storage volume 40 that is in operative communication with the control valve 46. Such communication may be via a controller, either wirelessly or in a hardwired configuration. In one embodiment, the control valve 46 remains in the closed condition until a predefined pressure is detected in the storage volume 40. Expulsion of the fuel contents within the storage volume 40 may continue until the storage volume 40 is completely empty. Alternatively, the storage volume 40 may be partially depleted during the open condition of the control valve 46.

In the closed condition, the control valve 46 restricts flow of the fuel 22, thereby not allowing the fuel 22 to completely pass through the secondary fuel line path 32 to the outlet 36. However, in the open condition, the control valve 46 allows the storage volume 40 to expel the fuel 22, either partially or completely, to be routed through the outlet 36 and into the main fuel line path 26. As shown, the outlet 36 is located downstream of the first orifice 28. In an embodiment having the piping structure 30 (i.e., pigtail), the outlet 36 is located upstream of the piping structure 30. The outlet 36 is positioned to rejoin the portion of the fuel 22 that was routed through the secondary fuel line path 32 into the main fuel line path 26.

By oscillating between an open condition and a closed condition of the control valve 46, the secondary fuel line path 32 imposes mass flow fluctuations or oscillations within the main fuel line path 26 and therefore the combustion assembly 14, advantageously oscillating flow pressure of the combustion assembly 14. Such an assembly reduces or avoids the need for phase-matching avoidance techniques that are otherwise required.

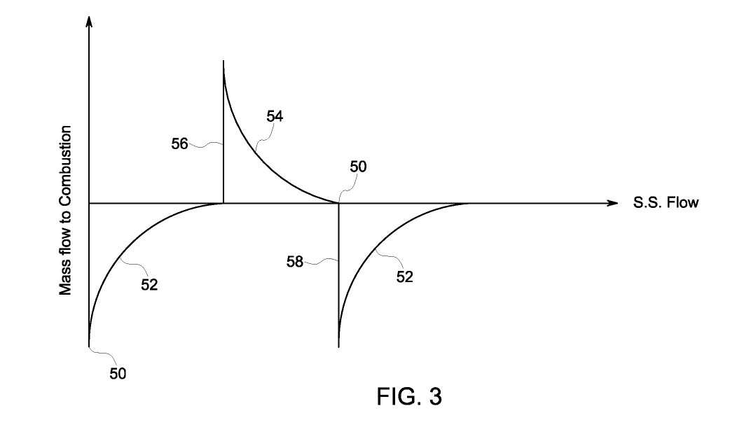

Referring to FIG. 3, an exemplary profile of accumulation and expulsion of the fuel 22 from the storage volume 40 is illustrated. In the illustrated embodiment, the mass flow of the fuel 22 for combustion, as measured within the main fuel line path 26 oscillates in a cyclical manner as a function of time or pressure within the storage volume 40. Points 50 represent an empty storage volume condition, points 52 represent a storage volume filling condition and point 54 represents a storage volume discharge condition. Segment 56 illustrates a spike in mass flow within the main fuel line path 26 due to the abrupt opening of the control valve 46. Conversely, a rapid loss in mass flow within the main fuel line path 26 is represented by segment 58 upon closing of the control valve 46.

Advantageously, oscillation of the mass flow provides flexibility to design for higher power requirements without being concerned about frequency and/or phase matching.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel supply system comprising:
a fuel manifold;
a main fuel line path configured to receive a fuel from the fuel manifold and route the fuel to a combustion inlet region;
a secondary fuel line path having an inlet configured to receive a portion of the fuel and an outlet configured to route the portion of the fuel to the main fuel line path through an outlet at a location of the main fuel line path that is downstream of the inlet of the secondary fuel line path; and
a storage volume fluidly coupled to the secondary fuel line path and configured to cyclically store and release the portion of the fuel.

2. The fuel supply system of claim 1, further comprising a control valve located along the secondary fuel line path between the storage volume and the outlet of the secondary fuel line path.

3. The fuel supply system of claim 2, wherein the control valve is in operative communication with the storage volume and configured to oscillate between an open condition and a closed condition.

4. The fuel supply system of claim 3, wherein the open condition of the control valve occurs in response to a first predefined pressure of the storage volume.

5. The fuel supply system of claim 4, wherein the closed condition of the control valve occurs in response to a second predefined pressure of the storage volume.

6. The fuel supply system of claim 3, wherein the control valve is configured to oscillate between the open condition and the closed condition as a function of time.

7. The fuel supply system of claim 1, further comprising a first orifice disposed in the main fuel line path to regulate a main fuel line path flow rate.

8. The fuel supply system of claim 7, further comprising a second orifice disposed in the secondary fuel line path to regulate a secondary fuel line path flow rate.

9. The fuel supply system of claim 7, wherein the inlet of the secondary fuel line path is located upstream of the first orifice and the outlet of the secondary fuel line path is located downstream of the first orifice.

10. The fuel supply system of claim 7, wherein the inlet of the secondary fuel line path is located between the fuel manifold and the first orifice.

11. The fuel supply system of claim 1, wherein the fuel comprises a gas fuel.

12. A fuel supply system for a gas turbine engine comprising:
a fuel manifold;
a main fuel line path configured to receive a fuel from the fuel manifold and route the fuel to a combustion inlet region;
a secondary fuel line path having an inlet configured to receive a portion of the fuel and an outlet configured to route the portion of the fuel to the main fuel line path through an outlet;
a storage volume fluidly coupled to the secondary fuel line path and configured to cyclically store and release the portion of the fuel;
a control valve located along the secondary fuel line path between the storage volume and the outlet of the secondary fuel line path, wherein the control valve is configured to oscillate between an open condition and a closed condition in response to a pressure detected within the storage volume;
a first orifice disposed in the main fuel line path to regulate a main fuel line path flow rate; and
a second orifice disposed in the secondary fuel line path to regulate a secondary fuel line path flow rate, wherein the inlet of the secondary fuel line path is located upstream of the first orifice and the outlet of the secondary fuel line path is located downstream of the first orifice.

13. The fuel supply system of claim 12, wherein the open condition of the control valve occurs in response to a first predefined pressure of the storage volume.

14. The fuel supply system of claim 13, wherein the closed condition of the control valve occurs in response to a second predefined pressure of the storage volume.

15. The fuel supply system of claim 12, wherein the inlet of the secondary fuel line path is located between the fuel manifold and the first orifice.

16. The fuel supply system of claim 12, wherein the fuel comprises a gas fuel.

17. A gas turbine system comprising:
a compressor;
a combustion assembly having at least one combustion chamber;
a turbine section; and
a fuel supply system configured to route fuel to the combustion assembly, the fuel supply system comprising:
a fuel manifold;
a main fuel line path configured to receive a fuel from the fuel manifold and route the fuel to a combustion inlet region of the combustion assembly;
a secondary fuel line path having an inlet configured to redirect a portion of the fuel away from the main fuel line path; and
a storage volume fluidly coupled to the secondary fuel line path and configured to cyclically store and release the portion of the fuel in response to a pressure differential between the main fuel line path and the secondary fuel line path.
